(19) United States
(12) Patent Application Publication
(10) Pub. No.: US 2003/0178221 A1
(43) Pub. Date: Sep. 25, 2003

(54) Anisotropically conductive film

(76) Inventors: Cindy Chia-Wen Chiu, San Dimas, CA (US); Hsiao Ken Chuang, Arcadia, CA (US)

Correspondence Address: Heidi A. Boehlefeld, Renner, Otto, Boisselle & Sklar, LLP, Nineteenth Floor, 1621 Euclid Avenue, Cleveland, OH, 44115-2191, US

(21) Appl. No.: 10/369,793

(22) Filed: Feb. 20, 2003

Related U.S. Application Data
(60) Provisional application No. 60/366,423, filed on Mar. 21, 2002.

(51) Int. Cl. H01B 7/00

(52) U.S. Cl. 174/117 F

(57) ABSTRACT

An anisotropically conductive structure for providing electrical interconnection between electronic components, and the process for making such anisotropically conductive structure. The anisotropically conductive structure includes a dielectric matrix having a substantially uniform thickness; and a plurality of conductive elements embedded in the dielectric matrix.

This application claims the benefit of Provisional patent application Serial No. 60/366,423, filed Mar. 21, 2002 entitled “Anisotropically Conductive Film.”

### FIELD OF THE INVENTION

The present invention is directed to an anisotropically conductive polymeric film for providing electrical interconnection between electronic components, and the process for making such anisotropically conductive film. More particularly, the anisotropically conductive polymeric film of the present invention has electrical conductors formed by embedding conductive particles in a dielectric polymeric matrix.

### BACKGROUND OF THE INVENTION

Anisotropically conductive films are well known and have been used commercially in the electronics industry for some time. Such films generally comprise a sheet-like, dielectric carrier material that is loaded with conductive particles. The particle loading is kept low so that formation of electroconductive paths in the X-and Y-axis direction of the carrier material is avoided. The film is rendered conductive via the particles only in the Z-axis direction of the material.

Anisotropically conductive films provide a convenient and useful way to electrically connect electrode pads on separate circuits or between layers of a multiple layer circuit. An anisotropically conductive film allows conduction between opposing electrodes through the film, but does not allow conduction in the plane of the film. Thus, adjacent electrode pads meant to conduct independently can remain electrically isolated from each other while being bonded and electrically connected to partner electrodes on opposing circuits or circuit layers. Insulated conductive particles are also used to prevent conduction in the plane of the film.

Anisotropically conductive films may be used in a variety of applications, such as the bonding of circuits and the bonding of components per unit area. Difficulties arise when higher density connections are desired. Higher density connections involve smaller spacings between electrodes as well as smaller electrode pads. Using randomly distributed conductive particles within an adhesive to connect such fine pitch circuits can lead to electrical shorts between adjacent electrodes. To overcome this problem, a lower loading volume of conductive particles in the adhesive is used. However, such lower loading volume often results in decreased reliability of the electrical connections due to the existence of fewer particles per connection, particularly when very small electrodes are used.

The present invention is directed to an anisotropically conductive structure having a predetermined array of conductive elements. The conductive particles may be randomly arranged or may be arranged in a predetermined pattern within the dielectric matrix, depending on the requirements of the electrical application. The spacing between the conductive elements as well as the density of the conductive elements can be customized for the particular circuit in which the anisotropically conductive structure is to be used. Using the method of making anisotropically conductive structures of the present invention, symmetrical and asymmetrical arrays of conductive particles within a dielectric matrix are produced.

### SUMMARY OF THE INVENTION

The present invention provides an anisotropically conductive structure comprising: a dielectric matrix having a substantially uniform thickness and having a first major surface and a second major surface; an array of conductive particles, having an average diameter substantially equal to the thickness of the dielectric matrix, embedded in the dielectric matrix and extending from the first major surface to the second major surface of the matrix. In another embodiment, the average diameter of the conductive particles is greater than the thickness of the dielectric matrix and the conductive particles protrude from the first major surface, the second major surface or the first and second major surfaces of the dielectric matrix. In yet another embodiment, the average diameter of the conductive particles is less than the thickness of the dielectric matrix and the conductive particles do not protrude from either the first or second major surfaces of the dielectric matrix. The anisotropically conductive structure may further comprise a first adhesive layer adhered to the first major surface of the matrix; and a second adhesive layer adhered to the second major surface of the matrix.

According to a method of the present invention, the anisotropically conductive structure can be made by a process comprising the steps of: providing a dielectric film having a first major surface and a second major surface; applying a plurality of conductive elements onto the first major surface of the dielectric film in a predetermined array; heating the conductive elements; and embedding the conductive elements in the dielectric film. In one embodiment, the process of making the anisotropically conductive film further comprises the step of applying an adhesive layer to one or both sides of the dielectric film. The adhesive layer may be releasably adhered to a release liner.

### BRIEF DESCRIPTION OF THE DRAWINGS

FIG. 1 is a cross-sectional view of one embodiment of the anisotropically conductive structure of the present invention.

FIGS. 2a-2d are cross-sectional views of alternative embodiments of the anisotropically conductive structure of the present invention.

FIG. 3 is a cross-sectional view of an alternative embodiment of the anisotropically conductive structure of the present invention in which an adhesive layer is adhered to the dielectric layer.

FIG. 4 is a cross-sectional view of the multi-layer structure used in the manufacturing process of the present invention.

FIG. 5 is a cross-sectional view of the anisotropically conductive structure of the present invention within an electrical device.

### DETAILED DESCRIPTION OF THE INVENTION

Anisotropically Conductive Structure:

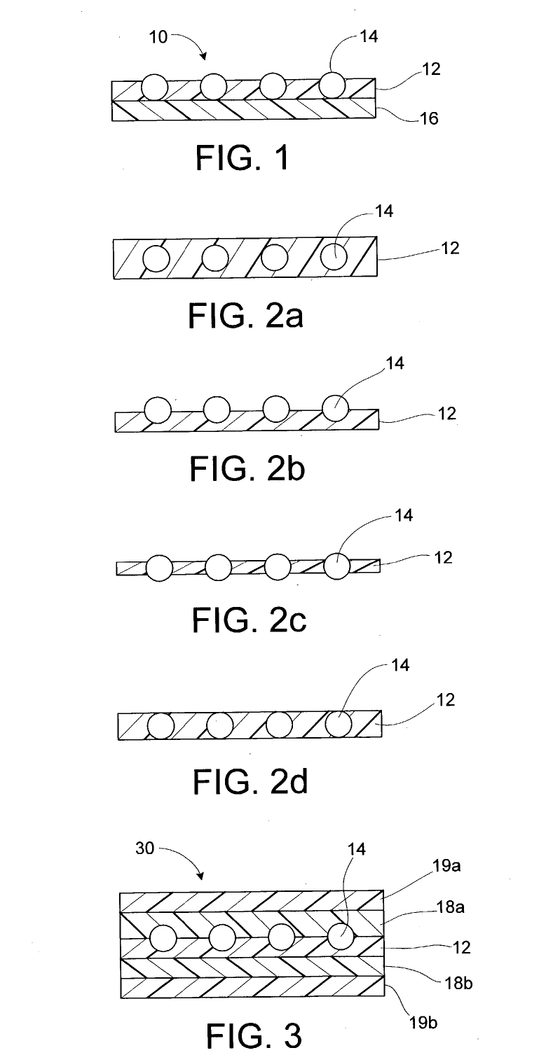

The anisotropically conductive structure of the present invention comprises a dielectric matrix having a plurality of conductive particles embedded within the dielectric matrix. FIG. 1 shows a cross-sectional view of one embodiment of the anisotropically conductive structure 10 of the present invention. Dielectric matrix 12 has a plurality of conductive particles 14 embedded therein. The conductive particles 14 protrude from at least the top surface of the dielectric matrix 12. Within the dielectric matrix, the conductive particles may be arranged in a symmetrical pattern, an asymmetrical pattern, or randomly. In this embodiment, a support layer 16 is releasably adhered to the bottom surface of the dielectric matrix 12. Dielectric matrix 12 comprises, in this embodiment, a tacky adhesive or film. When the dielectric layer comprises a non-tacky adhesive or a non-tacky film, support layer 16 is not required.

FIGS. 2a-2d illustrate alternative embodiments of the present invention. FIG. 2a illustrates the anisotropically conductive structure wherein the average diameter of the conductive particles is less than the thickness of the dielectric matrix and the conductive particles do not protrude from either the first or second major surfaces of the dielectric matrix. FIG. 2b illustrates the anisotropically conductive structure wherein the average diameter of the conductive particles is substantially the same, greater than or less than the thickness of the dielectric matrix and the conductive particles protrude from the first or second major surface of the dielectric matrix. FIG. 2c illustrates the anisotropically conductive structure wherein the average diameter of the conductive particles is greater than the thickness of the dielectric matrix and the conductive particles protrude from both the first and the second major surfaces of the dielectric matrix. FIG. 2d illustrates the anisotropically conductive structure wherein the average diameter of the conductive particles is substantially equal to the thickness of the dielectric matrix and the conductive particles extend from the first major surface to the second major surface of the dielectric matrix, without protruding from either the first or second major surfaces.

In another embodiment shown in FIG. 3, the anisotropically conductive structure 30 includes an adhesive layer (18a and 18b) adhered to each of the top and bottom surfaces of the dielectric matrix 12. Adhesive layers 18a and 18b may be of the same composition and thickness, or may be of different compositions and/or thicknesses. A release layer (19a and 19b) is releasably adhered to the outer surface of each of the adhesive layers 18a and 18b.

In yet another embodiment, adhesive layer 18a and/or 18b comprise a multilayer adhesive.

In one embodiment, the conductive particles may be arranged in a predetermined array. The desired spacing between conductive particles will depend on the electrode patterns on the circuits to be bonded. For example, in fine pitch applications, the spacing between conductive particles may be less than 10 μm. In one embodiment, the spacing between conductive particles is less than 5 μm. The conductive particle spacing is determined by the electrode pattern and the average particle size.

The conductive particles or elements are deposited onto the surface of the dielectric layer so that there is no more than one conductive particle or element in any given column perpendicular to the surface dielectric layer. In other words, the conductive particles or elements are not stacked on the dielectric layer. This ensures that each conductive pathway between circuit electrodes is through a single particle. In another embodiment, the particles are stacked to achieve conduction through the dielectric layer.

Dielectric Matrix:

The dielectric matrix can be described by referring to FIG. 1. The dielectric matrix is formed from a sheet 12 of polymeric material. Sheet 12 can be a single layer of a thermoplastic material or a laminate of different thermoplastic layers compatible with its intended application. The dielectric material may also comprise an elastomeric material. For example, the dielectric material acrylate polymers, ethylene-acrylate copolymers, ethylene-acrylic acid copolymer, ethylene-vinyl acetate copolymers, polyethylene, ethylene-propylene copolymers, acrylonitrile-butadiene copolymers, styrene-butadiene block copolymers, styrene-butadiene-styrene block copolymers, carboxylated styrene-ethylene-butadiene-styrene copolymers, epoxidized styrene-ethylene-butadiene-styrene copolymers, styrene-isoprene block copolymers, polybutadiene, ethylene-styrene-butylene block copolymers, polybutadiene, ethylene-styrene-ethylene block copolymers, polyvinyl butyral, polyvinyl formal, polyamides, polyimides, polystyrenes, polyurethanes, polysulfones, polysulfides, polyesters, polyvinyls, polyvinyl chloride, polyvinyl acetals, polyvinyl ethers, polycarbonates, polyketones, polyethers, phenoxy resins, nitrile-butadiene rubber, silicone rubber, styrene-butadiene rubber, chloroprene rubber, cyanate epoxy resins, phenol resins, and blends thereof.

The dielectric layer may comprise an adhesive layer. The adhesive may be tacky or non-tacky at room temperature. In one embodiment, the dielectric layer comprises a multilayer adhesive film.

The sheet 12 can have a generally planar geometry having, for example, a width W, a length L, and a thickness T. The width W can be constant across the sheet's length and can be of a dimension compatible with the equipment used to incorporate the sheet 12 into the desired final product. The length L can be a predetermined distance in the same general range as the width W or can be substantially longer so that the sheet 12 resembles a continuous web. In one embodiment, the thickness T is in the range of about 2 to about 50 microns. In another embodiment, the thickness T is in the range of about 10 to about 30 microns, and in another embodiment, about 15 to about 25 microns. The thickness T can be constant across the sheet's length and/or width.

The array-arrangement of the conductive particles 14 within the dielectric matrix 12 can be in aligned rows and columns, staggered rows and columns, and/or changing rows and columns. Additionally or alternatively, the spacing between the conductive particles 14 can be the same, can change proportionally, and/or can be different. Also, the conductive particles 14 can be randomly arranged, or asymmetrically arranged so that an array pattern or spacing sequence is not apparent. In one embodiment, the spacing between adjacent conductive particles 14 (center-to-center) is in the range of about 5 to 300 microns. In another embodiment, the spacing between adjacent conductive particles 14 is in the range of about 5 to 100 microns, and in another embodiment, about 5 to 40 microns. In yet another embodiment, the spacing between adjacent conductive particles 14 is in the range of about 40 to 100 microns.

Conductive Particles:

The conductive particles 14 are made of conductive material or of a non-conductive material having a contiguous conductive coating or coatings. Depending on the application, the conductive particles may be deformable and made of either a deformable metal or of a deformable core particle coated with one or more contiguous conductive coatings. Examples of conductive metals useful in the present invention include tin, lead, bismuth, zinc, indium, aluminum, copper, silver, gold, nickel, cobalt, iron, palladium, tungsten, gallium and their alloys, and mixtures thereof. The conductivity of metal particles may be increased by coating the particles with a higher conductivity metal such as copper, gold, silver, nickel, cobalt or platinum by, for example, electroplating. The conductive particles may also comprise metal-coated glass, metal-coated polymers and/or metal-coated ceramics. While spherical particles are preferred, particles of any shape may be used. In one embodiment, the conductive particles have an average diameter within the range of about 3 to about 50 microns. The diameter of the conductive particles may be less than, greater than or substantially equal to the thickness of the dielectric film. The conductive particles have a narrow size distribution.

Adhesives:

A wide range of adhesives may be used as the adhesive layers 18a and 18b of the anisotropically conductive structure of the present invention. Useful adhesives include pressure sensitive adhesives, thermoplastic adhesives or thermoset adhesives, e.g. a B-stage epoxy. Where the adhesive is tacky at ambient temperature, it is desirable to use a release liner to cover the adhesive. Examples of useful adhesives include acrylate polymers, ethylene-acrylate copolymers, ethylene-acrylic acid copolymers, ethylene-vinyl acetate copolymers, polyethylene, ethylene-propylene copolymers, acrylonitrile-butadiene copolymers, styrene-butadiene block copolymers, styrene-butadiene-styrene block copolymers, carboxylated styrene-ethylene-butadiene-styrene block copolymers, epoxidized styrene-ethylene-butadiene-styrene block copolymers, styrene-isoprene block copolymers, polybutadiene, ethylene-styrene-butylene block copolymers, polyvinyl butyral, polyvinyl formal, phenoxy resins, polyesters, polyurethanes, polyamides, polyvinyl acetal, polyvinyl ethers, polysulfones, nitrile-butadiene rubber, styrene-buradiene rubber, chloroprene rubbers, cyanate ester polymers, epoxy resins, silicone resins, phenol resins, photocurable resins, anaerobic resins and the like. These adhesive resins may be used independently or in blends of two or more. A particularly useful adhesive is a radiation curable adhesive, such as that described in copending application Ser. No. 09/594,229, which is hereby incorporated by reference.

If necessary, a curing agent and/or a curing catalyst may be used to increase the molecular weight of the non-conductive adhesive, either by cross-linking or polymerization. The curing mechanism can be initiated thermally or by radiation, such as by UV radiation, electron beam radiation or microwave radiation. Examples of curing agents and curing catalysts that may be used in the adhesive include those that conventionally have been used in conjunction with the adhesive resins described hereinabove. The method of curing the adhesive must be compatible with the apparatus used to bond the electronic circuit.

In one embodiment of the present invention, each of the adhesive layers 18a and 18b are coated onto a release liner (19a and 19b) and then transferred to the anisotropically conductive film. Prior to use, the release liner is removed.

In one embodiment of the present invention, adhesive 18 comprises a multilayer adhesive applied onto the anisotropically conductive film. The multilayer adhesive may be applied to the conductive film by, or example, coating, printing, or extruding the adhesive. Alternatively, a multilayer adhesive 18 is applied onto release liner 19, and then transferred to the anisotropically conductive film.

Process for Making the Anisotropically Conductive Film:

The process of making the anisotropically conductive film of the present invention generally comprises the steps of (a) providing a dielectric film having a first and second major surface; (b) applying a plurality of conductive particles onto the first major surface of the dielectric film in a predetermined pattern; (c) heating the conductive particles; and (d) embedding the conductive particles in the dielectric film. In one embodiment, the heating step and the embedding step are carried out simultaneously.

As shown in FIG. 1, the dielectric film may have a support film laminated to its lower surface for support. The support layer 16 is selected from materials having a melting temperature (or glass transition temperature of the material if the material does not have a melting temperature) substantially greater than the glass transition temperature (or melting temperature) of the dielectric layer 12. The ability of the support layer 16 to support the dielectric layer 12 during certain method steps can also be taken into consideration when choosing a support material. Suitable support materials include thermoplastic, and thermosetting materials compatible with the manufacturing method. Examples of particularly suitable support materials for support layer 16 include polyolefins; polyurethanes; polyesters such as, for example, PET; and PTFE.

The conductive particles are applied to the surface of the dielectric film by jetting, screen printing, or by any other printing, coating or application method in which the position of the particles can precisely controlled. In one embodiment, the conductive particles are accurately dispensed onto the surface of the dielectric film by a jetting method similar to ink-jet printing. This process deposits hot conductive spheres onto the surface of the dielectric film. The force of jetting the spheres forces the spheres into the dielectric matrix. Jetting spheres heated to a high temperature will also enable the spheres to penetrate into the dielectric film. An example of a another useful method of conductive particle deposition is that described in British patent application GB 2,330,331, in which an ink-jet printhead is used to eject droplets of conductive material that coalesce and form a three-dimensional feature.

In one embodiment, the conductive microspheres are first deposited into the recesses or indentations of a template having a predetermined pattern. The conductive microspheres are then transferred from the template to the surface of the dielectric film in the reverse pattern of the template.

The conductive particles are embedded into the dielectric film by first heating the conductive particles. The heated particles soften the polymeric material of the dielectric film surrounding the particles, resulting in the conductive particles penetrating the surface of the dielectric film. In one embodiment, the conductive particles are heated by near infrared radiation (NIR). Alternatively, the conductive particles may be heated prior to deposition onto the surface of the dielectric film. Pressure may be applied to the heated conductive particles on the softened dielectric film to force the conductive particles into the dielectric film.

In order for the dielectric film to soften upon contact with the heated conductive particles, the dielectric film comprises a thermoplastic film. A table of exemplary thermoplastic materials, and their glass transition temperatures, appears below as Table 1:

TABLE I

| Symbol | Polymer Chemical Name | T_{g} ° C. | T_{g} ° F. |
|---|---|---|---|
| PVC | Polyvinyl Chloride | 70 | 158 |
| Phenoxy | Phenoxy PKHH | 95 | 203 |
| PMMA | Polymethyl methacrylate | 100 | 212 |
| BPA-PC | Bisphenol-A Polycarbonate | 150 | 302 |
| COC | Cyclo-olefinic copolymer | 163 | 325 |
| Polysulfone | Polysulfone | 190 | 374 |
| Polyacrylate | Polyacrylate | 210 | 410 |
| PC | High T_{g} polycarbonate | 260 | 500 |
| PEIPI | Polyether imide | 260 | 500 |
| Polyurethane | Polyurethane | varies | varies |
| ABS | Acrylonitrile Butadiene Styrene | 60-100 | 140-212 |

### EXAMPLE

An anisotropically conductive film was prepared by first depositing conductive microspheres onto the surface of a ¼ inch Pyrex glass with a doctor blade. The conductive microspheres were polymeric spheres having a nickel and gold alloy coated on the surface of the spheres. The average diameter of the particles was 50 microns. The conductive microspheres were then overlaid with a 2 mil thick Kraton/HDPE multilayer film. On top of the multilayer film was laid a 31 mil thick silicone rubber layer for even pressure distribution. A layer of 2 mil PET film was placed on top of the silicone rubber to prevent the silicone rubber from sticking to the quartz window. The assembly was placed on a stainless steel plate and inserted into the press of an NIR lab commercially available from Adophos, with the quartz window on top and an air cylinder at the bottom. Near infrared (NIR) radiation penetrated through the quartz window and was absorbed by the metal particles. The conductive microspheres were heated by the near infrared radiation.

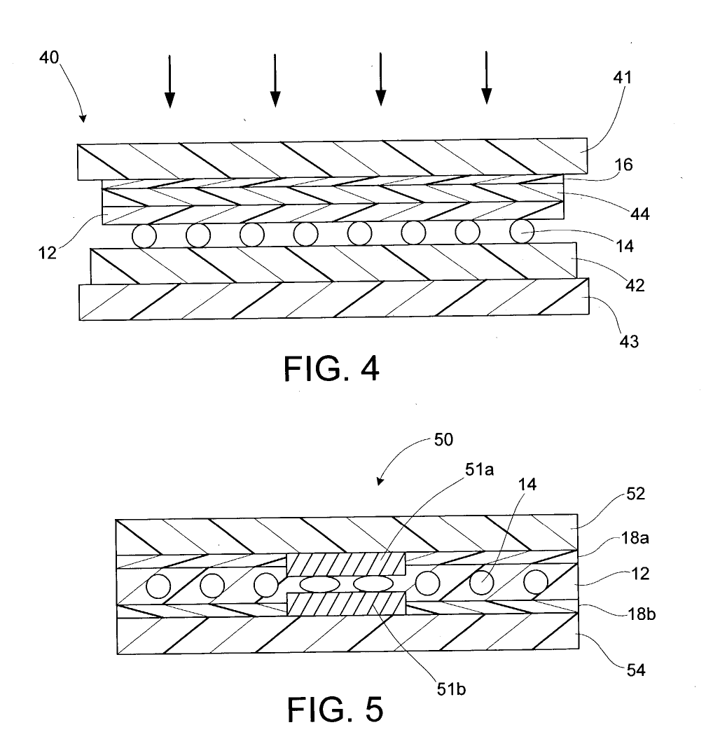

FIG. 4 illustrates the assembly 40 for the NIR radiation. Conductive microspheres 14 were deposited on the Kraton/HDPE film 12 with silicone rubber layer 44 and PET layer 16. This multilayer structure was sandwiched between quartz window 41 and heat resistant glass substrate 42. A metal plate 43 contacted glass substrate 42. Using 6 lamps of 4.4 KW per lamp at a distance of 1 inch, the microspheres were exposed for 6 seconds to 114 W/cm² of radiation. Pressure was applied by air cylinders to the assembly.

Once the conductive particle have been embedded into the dielectric film, the silicone rubber 16 can be removed (e.g., peeled) from the dielectric layer 12. An adhesive layer coated onto, or laminated to, a release liner can be applied to both sides of the dielectric sheet embedded with conductive particles to form the anisotropically conductive structure.

In another embodiment, the conductive particles are embedded within a dielectric film by compressing the conductive particles between two dielectric films. Heat and pressure are applied to the multi-layer structure to embed the conductive particles. As described above, an adhesive layer may be applied to each of the outer major surfaces of the multi-layer dielectric sheet embedded with conductive particles. The adhesive layers may be coated onto, or laminated to a release liner.

Prior to using the anisotropically conductive structure, the release liners are removed and the conductive matrix with the adhesive layers adhered thereto is positioned between opposing conductive pads of an electronic device. Heat and pressure, are applied to the electronic device to deform the dielectric matrix and adhesive layer so that electrical contact with the conductive particles is made between the opposing conductive pads.

In one embodiment, illustrated in FIG. 5, the anisotropically conductive structure of FIG. 3 is used to make electrical contact within an electronic device 50 that includes integrated circuit chip 52 and display panel 54. In this embodiment, electronic device 50 has bump pads 51a and 51b. Heat and pressure is applied to the device so that electrical connection between bump pad 51a and 51b is made through conductive particles 14. The portions of adhesive layers 18a and 18b above and below conductive particles 14 have been pushed out of the areas above and below conductive particles 14, leaving conductive particles 14 in direct contact with bump pads 51a and 51b. The temperature of the bonding process is generally about 100 to 180° C. The dielectric film is preferably softened at a temperature below 180° C. to allow the conductive particles to penetrate through the dielectric film and make direct contact with the bump pads. Preferably, the glass transition temperature, Tg, and the melt temperature, Tm of the dielectric film material is less than 180° C.

In one embodiment, the dielectric layer comprises a non-adhesive layer. This dielectric layer serves as an insulator to separate the spheres during the bonding process and will not deform as readily as an adhesive dielectric layer having a lower Tg. The position of conductive particles within the non-adhesive dielectric layer remains more fixed relative to the position of the conductive particles within an adhesive dielectric layer. A more fixed position allows for a more accurate prediction of the number of electrical contacts after bonding. Where the conductive particles comprise a metal coated sphere having a polymeric core, it is desirable to select conductive particles with a polymeric core having similar rheological properties to that of the dielectric layer. The dielectric layer and the spheres will than deform in a similar manner during the bonding procedure.

In one embodiment wherein the conductive particles protrude from both the first and second major surfaces of the dielectric layer, as in FIG. 2c, the dielectric layer material can have a Tg higher than 180° C. (the bonding temperature). In this embodiment, the conductive particles need only to penetrate through the adhesive layers 18a and 18b to make contact with the bump pads of the electronic device.

Although the invention has been shown and described with respect to certain preferred embodiments, it is obvious that equivalent and obvious alterations and m modifications will occur to others skilled in the art upon the reading and understanding of this specification. The present invention includes all such alterations and modifications and is limited only by the scope of the following claims.

1. An anisotropically conductive structure comprising:
a dielectric matrix having a substantially uniform thickness and having a first major surface and a second major surface; and
a plurality of conductive elements embedded in the dielectric matrix in a predetermined array.

2. The anisotropically conductive structure of claim 1 wherein the array is random.

3. The anisotropically conductive structure of claim 1 wherein the array is patterned.

4. The anisotropically conductive structure of claim 1 wherein the conductive elements comprise conductive microspheres having a narrow size distribution, wherein the diameter of the microspheres is less than the thickness of the matrix.

5. The anisotropically conductive structure of claim 1 wherein the conductive elements comprise conductive microspheres having a narrow size distribution, wherein the diameter of the microspheres is greater than the thickness of the matrix.

6. The anisotropically conductive structure of claim 1 wherein the conductive elements comprise a conductive microspheres having a narrow size distribution, wherein the diameter of the microspheres is substantially equal to the thickness of the matrix.

7. The anisotropically conductive structure of claim 1 wherein the conductive microspheres have a diameter within the range of about 3 to about 50 microns.

8. The anisotropically conductive structure of claim 1 wherein the conductive elements are selected from the group consisting of tin, lead, bismuth, zinc, indium, aluminum, copper, silver, gold, nickel, cobalt, iron, palladium, tungsten, gallium and alloys of these metals, metal-coated glass, metal-coated polymers and metal-coated ceramics.

9. The anisotropically conductive structure of claim 1 wherein the conductive elements comprise metal-coated polymeric particles.

10. The anisotropically conductive structure of claim 1 wherein the matrix comprises a polymeric film.

11. The anisotropically conductive structure of claim 10 wherein the matrix comprises a thermoplastic film.

12. The anisotropically conductive structure of claim 10 wherein the matrix comprises an adhesive film.

13. The anisotropically conductive structure of claim 12 wherein the matrix comprises a multi-layer adhesive film.

14. The anisotropically conductive structure of claim 10 wherein the matrix comprises a polymeric film selected from the group consisting of acrylate polymers, ethylene-acrylate copolymers, ethylene-acrylic acid copolymer, ethylene-vinyl acetate copolymers, polyethylene, ethylene-propylene copolymers, acrylonitrile-butadiene copolymers, styrene-butadiene block copolymers, styrene-butadiene-styrene block copolymers, carboxylated styrene-ethylene-butadiene-styrene copolymers, epoxidized styrene-ethylene-butadiene-styrene copolymers, styrene-isoprene block copolymers, polybutadiene, ethylene-styrene-butylene block copolymers, polybutadiene, ethylene-styrene-ethylene block copolymers, polyvinyl butyral, polyvinyl formal, polyamides, polyimides, polystyrenes, polyurethanes, polysulfones, polysulfides, polyesters, polyvinyls, polyvinyl chloride, polyvinyl acetals, polyvinyl ethers, polycarbonates, polyketones, polyethers, phenoxy resins, nitrile-butadiene rubber, silicone rubber, styrene-butadiene rubber, chloroprene rubber, cyanate epoxy resins, phenol resins, and blends thereof.

15. The anisotropically conductive structure of claim 10 wherein the matrix comprises a multilayer polymeric film.

16. The anisotropically conductive structure of claim 1 wherein the thickness of the matrix is in the range of 2 to 50 microns.

17. The anisotropically conductive structure of claim 1 further comprising a first adhesive adhered to the first major surface and a second adhesive layer adhered to the second major surface of the matrix.

18. The anisotropically conductive structure of claim 1 further comprising a release liner on the first adhesive layer and the second adhesive layer.

19. A method of making an anisotropically conductive structure comprising:
providing a dielectric film having a first and second major surface;
applying a plurality of conductive particles onto the first major surface of the dielectric film in a predetermined array;
heating the conductive particles; and
embedding the conductive particles in the dielectric film.

20. The method of claim 19 wherein the heating and embedding steps are carried out simultaneously.

21. The method of claim 19 wherein the embedding step comprises applying pressure to the conductive particles.

22. The method of claim 19 wherein the predetermined array is random.

23. The method of claim 19 wherein the predetermined array is a pattern.

24. The method of claim 19 wherein the conductive particles are applied to the surface of the dielectric film by printing.

25. The method of claim 19 wherein the conductive particles are applied to the surface of the dielectric film by jetting.

26. The method of claim 19 wherein the conductive particles are applied to the surface of the dielectric film by transferring the conductive particles from a template.

27. The method of claim 19 wherein the conductive particles are heated by radiation.

28. The method of claim 27 wherein the radiation is near infrared radiation.

29. The method of claim 19 further comprising applying an adhesive layer to each of the first and second major surfaces of the dielectric film.

30. The method of claim 29 wherein a release liner is adhered to the adhesive layer applied to the first and second major surfaces of the dielectric film.

31. The method of claim 19 wherein the second major surface of the dielectric film is adhered to a support layer.

32. The method of claim 31 further comprising removing the support layer after embedding the conductive particles in the dielectric film.

33. The method of claim 19 wherein the dielectric film comprises a thermoplastic material.

34. The method of claim 19 wherein the dielectric film comprises an elastomeric material.

35. The method of claim 19 wherein the dielectric film comprises a multilayer film.

36. The method of claim 19 wherein the dielectric film comprises an adhesive film.

37. The method of claim 19 wherein dielectric film comprises a multilayer adhesive film.

38. The method of claim 19 wherein the thickness of the dielectric film is in the range of 2 to 50 microns.

39. The method of claim 19 wherein the conductive particles are selected from the group consisting of tin, lead, bismuth, zinc, indium, aluminum, copper, silver, gold, nickel, cobalt, iron, palladium, tungsten, gallium and alloys of these metals, metal-coated glass, metal-coated polymers and metal-coated ceramics.

40. The method of claim 19 wherein the conductive particles comprise metal-coated polymeric particles.

41. The method of claim 19 wherein the average diameter of the conductive particles is 3 to 50 microns.

42. A method of making an anisotropically conductive structure comprising:
providing a first dielectric film having a first and second major surface;
applying a plurality of conductive particles onto the first major surface of the dielectric film in a predetermined array;
applying a second dielectric film having a first and second major surface to the first major surface of the first dielectric film such that the conductive particles are between and in contact with the first major surface of the first dielectric film and the first major surface of the second dielectric film to form a multi-layered structure; and
applying heat and pressure to the multi-layered structure to embed the conductive particles in the dielectric films.
